(19) United States
(12) Patent Application Publication
(10) Pub. No.: US 2012/0299713 A1
(43) Pub. Date: Nov. 29, 2012

(54) METHODS AND SYSTEMS OF COLLISION AVOIDANCE AND/OR ALERTING FOR USERS OF MOBILE COMMUNICATION DEVICES

(76) Inventors: Liron Elia, Kiryat-Ata (IL); Yossi Ilia, Herzlia (IL); Guy Rodoy, Haifa (IL)

(21) Appl. No.: 13/576,679

(22) PCT Filed: Feb. 3, 2011
(86) PCT No.: PCT/IL2011/000127

§ 371 Date: Aug. 2, 2012

Related U.S. Application Data
(60) Provisional application No. 61/337,269, filed on Feb. 3, 2010.

(51) Int. Cl. G08B 1/08

(52) U.S. Cl. 340/435

(57) ABSTRACT

A method of alerting a user of a mobile communication device having a processor about a risk arising from proximate drivers or pedestrians. The method comprises receiving a list of a plurality of proximate mobile communication devices from a central unit via a network, establishing a peer to peer (P2P) connection with each the proximate mobile communication device, acquiring positioning data from each the proximate mobile communication device via a respective the P2P connection, locally using the processor for calculating at least one potential collision course with at least one of the plurality of proximate mobile communication devices according to the positioning data, and locally presenting an alert indicative of a risk to the user according to the at least one potential collision course.

### RELATED APPLICATION

This application claims priority from provisional patent application No. 61/337,269 filed on Feb. 3, 2010. The contents of the above document is incorporated by reference as if fully set forth herein.

### FIELD AND BACKGROUND OF THE INVENTION

The present invention, in some embodiments thereof, relates to alerting systems and methods and, more particularly, but not exclusively, to methods and systems of collision avoidance and/or alerting for users of mobile communication devices.

Car accidents are one of the most serious problems in the modern world, both in terms of personal deaths and injuries, and in financial losses suffered as a result of accidents. Human suffering caused by death or injury from such accidents is immense. In addition, the costs of medical treatment, permanent injury to accident victims resulting in loss of life opportunities, and financial losses resulting from damage to automobiles and other valuable objects or structures involved in such accidents are staggering. Providing improved systems and methods to minimize such personal and financial losses is an urgent and very important problem.

During the last years various systems and methods have been developed to provide infrastructure for preventive communication among vehicles. This communication is described, for example, in U.S. Pat. No. 5,506,584 to Boles relates to a system for communication between vehicles through a transmit and transponder relationship. The patent mentions that there may be as many as 90 vehicles within one half mile of an interrogation device in a multi-lane environment, where many of them may be at the same or nearly the same range. Boles utilizes a transponder device, the coded responses which are randomized in time, and an interrogation device which processes the return signals to provide vehicle identification, speed, location and transponder status information on vehicles to an operator or for storage in memory. No mention is made of how a vehicle knows its location or how accurate that knowledge is and therefore how it can transmit that location to other vehicles.

Another example is provided in U.S. Pat. No. 5,128,669 to Dabbs provides for two-way communication and addressing messages to specific vehicles. This is unnecessary and the communications can be general since the amount of information that is unique to one vehicle is small. A method of handing bi-directional communication is discussed in U.S. Pat. No. 5,506,584 to Boles.

### SUMMARY OF THE INVENTION

According to some embodiments of the present invention, there is provided a method of alerting a user of a mobile communication device having a processor about a risk arising from proximate drivers or pedestrians. The method comprises receiving a list of a plurality of proximate mobile communication devices from a central unit via a network, establishing a peer to peer (P2P) connection with each proximate mobile communication device, acquiring positioning data from each proximate mobile communication device via a respective the P2P connection, calculating, using the processor, at least one potential collision course with at least one of the plurality of proximate mobile communication devices according to the positioning data, and locally presenting an alert to the user according to the calculation.

Optionally, the positioning data comprises pseudorange.

Optionally, the positioning data comprises positioning coordinates corrected according to pseudorange.

Optionally, the calculating comprises calculating double difference pseudorange measurements according to the positioning data and using the double difference pseudorange measurements for determining the at least one potential collision course.

Optionally, the calculating comprises: calculating a plurality of risk levels each according to another the potential collision course, prioritizing the plurality of risk levels, and generating the alert according to the prioritization.

More optionally, the method further comprises repeating the calculating to update the prioritization.

More optionally, the prioritizing is performed to a sub group of the plurality of proximate mobile communication devices, the sub group is selected according to an analysis of the at least one potential collision.

Optionally, the calculating further comprises calculating at least one risk level according to the at least one potential collision course and at least one location based event of a respective the proximate mobile communication device.

More optionally, the at least one location based event is selected from a group consisting of a presence in an alcohol serving location, a presence in an unfamiliar region, a presence in vehicle moving longer than a certain period.

Optionally, the calculating further comprises calculating at least one risk level according to the at least one potential collision course and an analysis of driving history of a proximate user of a respective the proximate mobile communication device.

Optionally, the calculating comprises detecting at least one accident bias driving habit of the proximate user according to the driving history.

Optionally, the calculating further comprises calculating at least one risk level according to the at least one potential collision course and personal information of a user of a respective the proximate mobile communication device.

More optionally, the personal information is extracted from at least one of a social network page, a social network feed, and a social network activity of the user.

More optionally, the personal information comprises demographic data.

Optionally, the calculating further comprises calculating at least one risk level according to the at least one potential collision course and technical data of a vehicle driven by a user of a respective the proximate mobile communication device.

Optionally, the calculating further comprises calculating at least one risk level according to the at least one potential collision course and a detection of human communication established via a respective the proximate mobile communication device.

Optionally, the method further comprises performing a check to determine if respective the proximate mobile communication device is used for human communication; wherein the calculating further comprises calculating at least one risk level according to the at least one potential collision course and the check.

Optionally, the method further comprises detecting an accident according to an analysis of the at least one potential collision course and forwarding a notification indicative of the accident to a remote control unit.

Optionally, the method further comprises storing the at least one potential collision course for generating a report.

Optionally, the positioning data comprises a motion vector and a location.

Optionally, the acquiring comprises sending a request for the positioning data to each proximate mobile communication device via a respective the P2P connection and intercepting a response to the request.

More optionally, the request comprises current positioning data of the mobile communication device.

According to some embodiments of the present invention, there is provided a system of alerting a plurality of users of a plurality of mobile communication devices about risks arising from proximate drivers or pedestrians. The system comprises a central unit which monitors the location of a plurality of mobile communication devices in a plurality of groups each indicative of another of a plurality of traffic areas in a region and a plurality of client modules configured for being installed in the plurality of mobile communication devices so as to establish a plurality of peer to peer (P2P) connections among members of each group. Each client module receives a list defining a respective the group according to its respective the traffic area from the central unit, acquires positioning data from each member of the respective group via the respective P2P connections, calculates at least one potential collision course according to the positioning data, and locally presents an alert indicative of at least one risk to the respective user according to the at least one potential collision course.

Optionally, the list comprises a plurality of unique identifications (IDs) each one another member of a respective the group.

Optionally, positioning data comprises location coordinates, movement direction, and velocity.

Optionally, the central unit computes and updates the plurality of groups according to positioning data received from the plurality of mobile communication devices via a wireless communication network in real time.

Optionally, the central unit computes the plurality of groups according to a member of a group consisting of: a traffic load, an estimated velocity of a vehicle, an estimated range of velocities of vehicles, an average period which driver spend in a traffic area, a mean of periods which drivers spend in a traffic area, a risk having an accidence in a traffic area, and statistical analysis of traffic patterns in a traffic area.

Optionally, the plurality of mobile communication devices are cellular phones.

According to some embodiments of the present invention, there is provided a method of alerting at least one of drivers and pedestrians about risks. The method comprises monitoring positioning data of each of a plurality of mobile communication devices in real time, each mobile communication device being associated with at least one of a driver and a pedestrian, logging at least one of a location based event and a driving habit for each mobile communication device according to the positioning data, detecting an accident prone proximity between first and second of the plurality of mobile communication devices according to respective the positioning data, in real time, evaluating a risk for a first user of the first mobile communication device from a second user of the second mobile communication device as a function of respective the accident prone proximity and respective the at least one of the location based event and the driving habit, and outputting an alert indicative of the risk to the first mobile communication device in real time.

According to some embodiments of the present invention, there is provided a system of alerting at least one of drivers and pedestrians about risks. The system a communication unit for receiving positioning data of each of a plurality of mobile communication devices via a network, each mobile communication device being associated with at least one of a driver and a pedestrian, an event module for logging at least one of a location based event and a driving habit for each mobile communication device according to respective the positioning data, and a risk module for evaluating a risk for a first user of the first mobile communication device from a second user of the second mobile communication device as a function of respective the positioning data and respective the at least one of the location based event and the driving habit. The communication unit forwards at least one alert indicative of the risk to the first mobile communication device in real time.

According to some embodiments of the present invention, there is provided a network of a plurality of mobile communication devices, each mobile communication device comprises a location service module which acquires related pseudorange and local position coordinates, a communication unit which receives pseudorange and position coordinates of each of other the mobile communication device, a computing unit which calculates double difference pseudorange measurements according to the received pseudorange and position coordinates and the related pseudorange and local position coordinates, and presentation unit which alerts a respective user according to the calculation.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an alert system of alerting a plurality of users of a plurality of mobile communication devices about risks arising from proximate drivers or pedestrians, according to some embodiments of the present invention;

FIG. 2 is a flowchart of a method of alerting a user of a mobile communication device about a risk arising from proximate drivers or pedestrians having mobile communication devices, according to some embodiments of the present invention;

FIG. 3 is a schematic illustration of an exemplary road with three vehicles;

FIG. 4, is a flowchart of processes which occur at the implementing mobile communication device based on differential GPS calculations, according to some embodiments of the present invention; and

FIG. 5, which is a flowchart of a method of alerting driver(s) and/or pedestrian(s) about risks according to positioning data and additional user related data, according to some embodiments of the present invention.

### DESCRIPTION OF EMBODIMENTS OF THE INVENTION

The present invention, in some embodiments thereof, relates to alerting systems and methods and, more particularly, but not exclusively, to methods and systems of collision avoidance and/or alerting for users of mobile communication devices.

According to some embodiments of the present invention there are provided methods and systems of alerting a plurality of users of mobile communication devices, such as cellular phones, about risks arising from one another. Optionally, the users are drivers and/or pedestrians and the alerts are set to allow preventing potential collisions and/or avoiding hazardous proximity to risky drivers. In these embodiments, the system includes a central unit, such as a network connected server, which is set to monitor the location of the mobile communication devices and to divide them to different groups where each group is associated with a different traffic area. The distribution to different traffic area is optionally dynamic and updated in real time according to the location of the mobile communication devices and/or according to changes in the traffic load in different regions. For example, a traffic area may be divided to a number of traffic areas if the load increases a certain threshold. The system further includes a plurality of client modules, each installed in another mobile communication device. These modules are set to receive information about their particular group from the central unit and to establish, using the communication means of the hosting mobile communication device, peer to peer connections with the members in their particular group. These peer to peer connections allow each one of the client modules to gather positioning and/or risk level data pertaining to proximate drivers, bikers, cyclers, pedestrians, and/or vehicles that accommodate passengers with mobile communication devices, such as trains or buses from other client modules.

Optionally, the method, which may be implemented by one of the mobile communication devices, is based on receiving a list specifying the members of the group of a plurality of proximate mobile communication devices from the central unit via the network. The list, which optionally includes unique identifications (IDs), such as Internet Protocol addresses, caller IDs and/or unique encrypted IDs, is then used to establishing peer to peer connections with each one of the proximate mobile communication devices defined in the list. These connections are used to acquire positioning and/or risk level data of the proximate mobile communication devices. Now, one or more potential collision courses with and/or hazardous proximity to users of the proximate mobile communication devices may be calculated according to the received positioning and/or risk level data. Based on this calculation, one or more alerts may be locally presented to the user of the mobile communication device, for example as a voice alert, a display of a risk indicator, and/or by any other alert.

According to some embodiments of the present invention there are provided methods and systems of monitoring and alerting at least one of drivers and pedestrians about risks arising from one another. The method is based on the ability to monitor positioning data of each of a plurality of mobile communication devices in real time where each mobile communication device is associated with a driver and/or a pedestrian. The positioning data may be gathered by an integral location service module, such as a GPS module and/or from an external GPS unit which communicates therewith, for example via Bluetooth™ communication protocol.

Then, accident prone proximity between at least one pair of the mobile communication devices is detected according to the positioning data. When implemented one or more location based event(s) and/or driving habits are logged per mobile communication device according to its positioning data. For example, location based events, such as presence in alcohol serving locations, such as bars, and/or continuous driving and driving habits, such as irregular velocity, frequent velocity changes, driving paths stability, sudden stops, sudden accelerations, sudden turns and the like may be logged. Now, a risk for one of the users of mobile communication device from another is evaluated as a function of the respective accident prone proximity and the respective location based event(s) and/or driving habits. This allows outputting an alert indicative of the risk to one of the mobile communication devices in real time.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

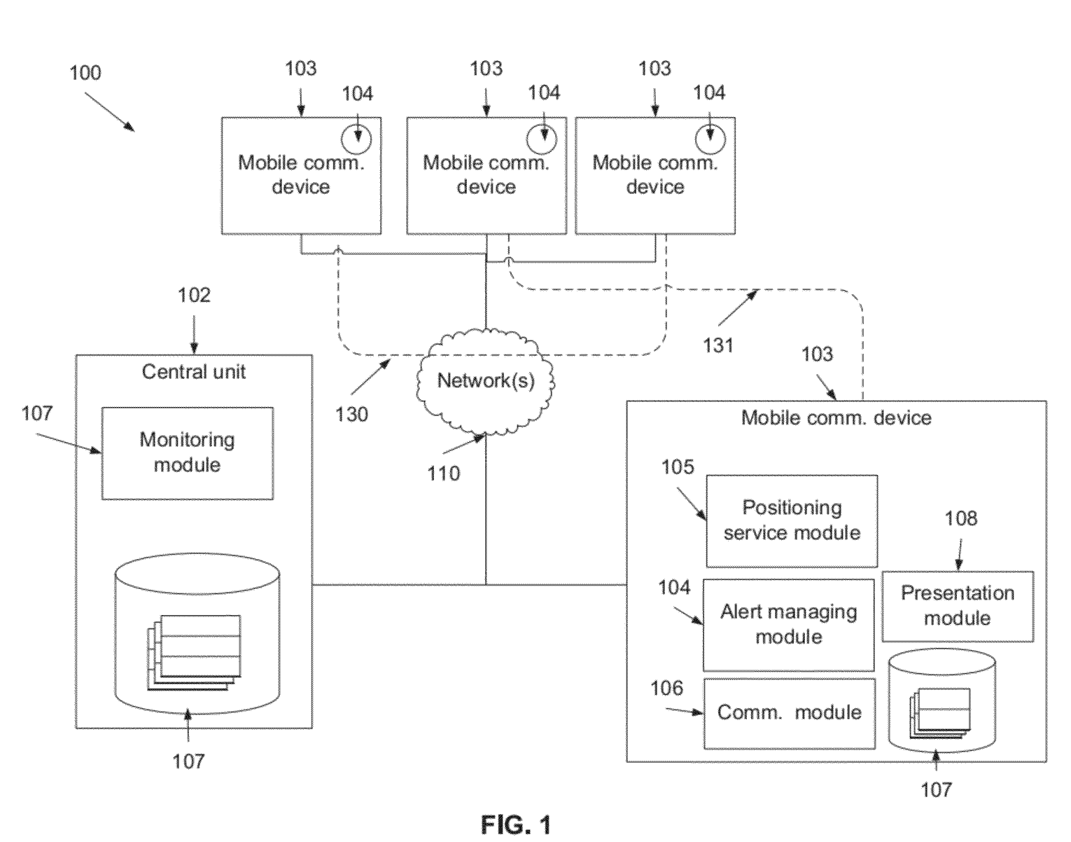

Reference is now made to FIG. 1, which is a schematic illustration of an alert system 100 of alerting a user of a mobile communication device 103 about risks arising from and/to posed to other users of other mobile communication devices, such as drivers and/or pedestrians, which are located in proximity thereto, according to some embodiments of the present invention. The alert system 100 comprises a central unit 102 which communicates with a plurality of client modules, referred to herein as alert managing modules 104 which are installed in a plurality of mobile communication devices 103. The alert managing module 104 may be an application program (app) installed on one of the mobile communication devices 103, for example an iPhone app, an android app and the like, an add on to another application, such as a navigation service and/or part of the operating system of the mobile communication device 103. As used herein, a mobile communication device means a cellular telephone, a Smartphone, a text messaging device, a wireless, two-way communication device designed to receive and transmit voice or text communication, and any device that enables a user in a vehicle and/or a pedestrian to transmit and receive audio signals to and from another user or audio recording device located outside the vehicle. Optionally, the central unit 102 is implemented as one or more servers which communicate with the plurality of alert managing modules 104 over a network 110, such as a cellular network, a wireless local area network (WLAN), a radio communication network, and the like. As used herein a WLAN connection may be based on the 802.11 standard and/or variants and alternatives, such as the WLAN interoperability forum and the European HiperLAN specification had made rapid progress, and the unlicensed personal communication services (PCS), WiMAX, LTE, and the proposed SUPERNet, also known as U-NII. The WLAN standard and/or variants and alternatives are incorporated herein by reference. Each alert managing module 104 is set to establish one or more peer to peer (P2P) connections with other alert managing modules 104 over the network(s) 110. The P2P connection is established using the communication modules 106 of the peering mobile communication devices 103, for example the cellular transceiver, the WLAN transceiver, and/or any radio communication transceiver. The P2P connections optionally allow sending messages such as transmission control protocol internet protocol (TCP/IP) messages or any message which comply with a P2P connection protocol, such as P2P Wi-Fi™, for example as further described below.

As the alert managing modules 104 are installed on the mobile communication devices 103, the alert system 100 may not require designated hardware at the client side, namely at the vehicles and/or as part of the pedestrian equipment, in order to provide alerts. The alerts are received from the alert system 100 by installing the alert managing module 104 on a mobile communication device 103, for example as an application program on a cellular phone and/or tablet. As the communication among the mobile communication devices 103 and the central unit 102 is done over a network 110 such as a cellular network and/or WLAN, environment conditions have limited affect thereupon. It should be noted that as the alert managing module 104 is installed in a mobile communication device 103, alerts may be received regardless to the type of vehicle that is used by the user of the mobile communication device 103, for example a bike, a motorcycle, a car, a track and/or skateboard. The alert managing module 104 may be installed on various mobile communication devices of various manufactures regardless to its operating system. The alert managing module 104 may be downloaded from a web server and/or an app store and/or pre-installed in the mobile communication device 103.

The central unit 102 divides a regions, such as one or more countries and cities, to a plurality of traffic areas, for example based on traffic load and/or patterns. In each traffic area, the central unit 102 manages a group of mobile communication devices 103 which have been identified as located in the traffic area. As further described below, a P2P connection is established and potential collision course(s) and/or accident prone proximities are calculated for each pair of mobile communication devices 103 in a certain traffic area. For brevity potential collision course(s) and/or accident prone proximities may be referred to herein interchangeably. These actions require computational power and communication bandwidth allocation from each mobile communication device 103. Thus, the number of members of each group affects the required computational load and bandwidth allocation from each mobile communication device in the group. Optionally, the size of each traffic area is defined according to the allowed, average and/or mean velocity of drivers therein. The higher is the velocity, the larger is the traffic area. Additionally or alternatively, the traffic areas are set according to traffic load. In such an embodiment, different traffic areas have different areas where smaller areas have more traffic per meter than larger areas. Additionally or alternatively, the size of each traffic area is defined according to the average and/or mean of the periods which drivers spend therein. In such embodiments, the traffic area may be adjusted to the minimum while avoiding frequent swap among traffic areas per mobile communication device 103. The velocity and/or periods may be provided according to a statistical analysis of traffic data. Additionally or alternatively, the traffic areas are set according to risk level. The risk level may be determined according to statistical data pertaining to the number of accidents, driver reports, police data and/or the like. In such an embodiment, the size of a traffic area is smaller when the risk level is higher.

The central unit 102 attributes the mobile communication devices 103 to different groups in different traffic areas according to their current or estimated location. Optionally, the central unit 102 receives positioning data from each one of the mobile communication devices 103 and attributes them to groups accordingly. Optionally, the alert managing module 104 extracts positioning data from a positioning service module 105 either installed on the mobile communication devices 103 and/or communicating therewith, for example an external GPS unit. The positioning service module 105 is optionally a global positioning system (GPS) tracker. Optionally, the alert managing module 104 extracts positioning data from a network service provider, for example by Cell ID localization, such as global system for mobile communications (GSM) localization. For example, the positioning data includes location coordinates and a motion which optionally includes movement direction and velocity. The extracted positioning data is sent using a communication module 106 of the mobile communication device 103, such as a cellular transmitter/receiver, a WLAN transmitter and/or the like, to the central unit 102. The positioning data may be sent periodically, for example every about a second and/or when the mobile communication device 103 changes its position and/or moves a certain distance. Optionally, the positioning Data is provided with the unique identification (ID) of the respective mobile communication device 103, for example its internet protocol (IP) address. Optionally, the rate in which the positioning data is sent changes according to the velocity of the mobile communication device 103, as indicated by the positioning data.

The central unit 102 updates the group of mobile communication devices 103 in each traffic area according to the received positioning data. This allows updating each mobile communication device 103 with a list that includes the unique IDs of other mobile communication devices 103 located in proximity thereto, for example in the same traffic area. Such a list may be sent periodically, upon update, for example, when one or more mobile communication devices 103 enter and/or leave a certain traffic area. Optionally, the traffic area are documented in a repository 107 and updated dynamically according to the positioning data that is accumulated form the mobile communication devices 103, for example as further described below.

The alert managing module 104 communicates with the positioning service module 105 of the hosting mobile communication device 103 so as to acquire positioning data therefrom. The positioning data may be transferred to proximate mobile communication devices 103 and/or used for estimating a risk arising therefrom, for example as further described below.

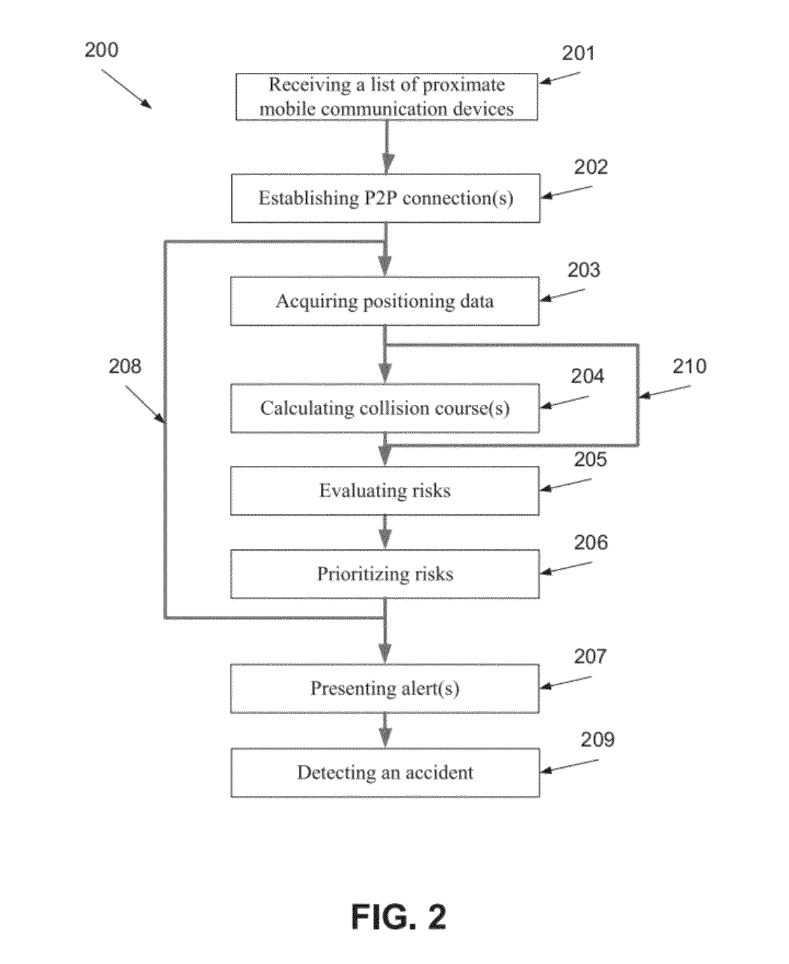

Reference is now also made to FIG. 2, which is a flowchart of a method 200 of alerting a user of a mobile communication device, such as 103, about a risk arising from proximate drivers or pedestrians having mobile communication devices, for example using the method depicted in FIG. 1, according to some embodiments of the present invention. The method 200 is implemented by a mobile communication device, which may be any of mobile communication devices 103, for example using the processor thereof and the aforementioned alert managing module 104. This mobile communication device may be referred to as an implementing mobile communication device.

First, as shown at 201, a list of a plurality of proximate mobile communication devices is received from a central unit, such as 102, via a network, such as 110. The list optionally includes the members of the group of mobile communication devices 103 which are identified as being located at the same traffic area as the implementing mobile communication device. Optionally, the list includes unique IDs of the members of the group of mobile communication devices 103, for example their IPs and/or caller ID messages. The unique IDs may be encrypted to maintain the privacy of the users. The list may be sent using a cellular service, for example by sending a cellular service message, a short message service (SMS) message, an SMS cell broadcasting (SMS CB) message and/or via the internet, for example using a wireless application protocol (WAP) message and/or the like. As outlined above, the list may be updated periodically, for example every 10 sec-30 sec, and any intermediate or shorter period, or upon an update thereof. Optionally, the mobile communication devices 103 sends a request for an update of the list whenever a velocity above a certain threshold for a certain period and/or a positioning change above a certain threshold is detected, for example if the positioning service module 105 thereof indicates on a change of more than 100 meters or less and/or whenever.

Now, the implementing mobile communication device, as shown at 202, establishes a P2P connection with each member in the received list. The P2P connection may be established via the networks 110, as shown at 130, or directly, for example using RF transceivers and/or P2P over WLAN connection, such as independent basic service set (IBSS). For example, the 802.11 standard has two basic modes of operation which may be used: Ad hoc mode that enables peer-to-peer transmission between mobile communication devices 103 and an infrastructure mode in which the mobile communication devices 103 may communicate through an access point that serves as a bridge to a wired network infrastructure. Such access points may be deployed in the different traffic areas.

As outlined above, each alert managing module 104 gathers positioning data pertaining to the hosting mobile communication device 103. As shown at 203, this allows the alert managing module 104 of the implementing mobile communication device 103 to use the P2P connections for acquiring positioning data from each one of the proximate mobile communication devices 103 in the list. For example, the alert managing module 104, of the implementing mobile communication device, sends a request for positioning data to each one of the alert managing modules 104 of the members in the list. Each one of these alert managing modules 104 gathers positioning data pertaining to its respective hosting mobile communication device 103 and sends, in response to the request, the positioning data, which is optionally relative. Optionally, in order to allow the implementing mobile communication device to update simultaneously the mobile communication devices 103 about its location, the request for positioning data includes the positioning data of the implementing mobile communication device.

Now, as shown at 204, the alert managing module 104 optionally calculates, using the processor of the implementing mobile communication device, potential collision courses, each with one of the proximate mobile communication devices. Each one of the potential collision courses is calculated according to the positioning data acquired from one of the proximate mobile communication devices and the positioning data of the implementing mobile communication device. The calculation of a potential collision course may be based on the current movement vector of the implementing mobile communication device 103 and/or on one or more optional movement vectors of the implementing mobile communication device 103. The potential collision course may be based on the current movement vector of the proximate mobile communication devices 103 and/or on one or more optional movement vectors of the proximate mobile communication device 103.

Optionally, each potential collision course between the implementing mobile communication device 103 and a certain proximate mobile communication device 103 is calculated according to the location and motion vector of each one of them.

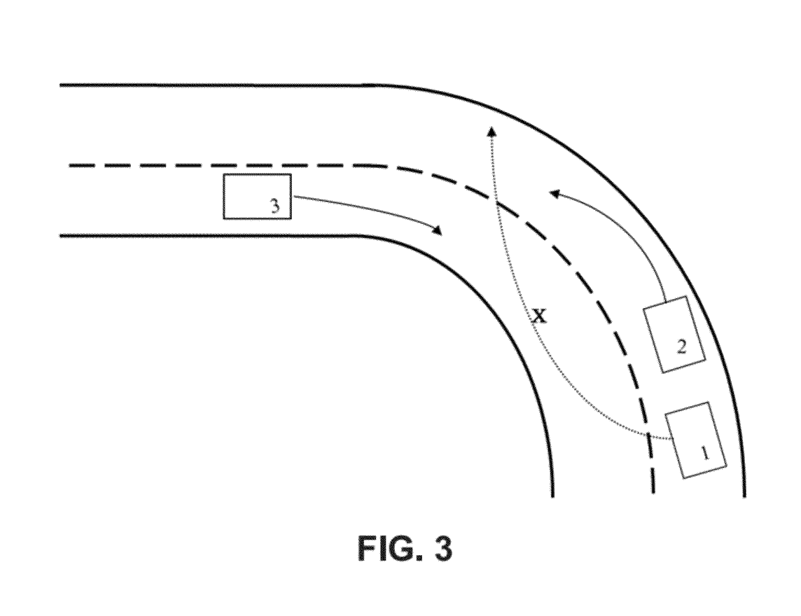

Optionally, each potential collision course is calculated based on an analysis of the arrangement of the roads. in proximity to the implementing mobile communication device 103. This information may be gathered from a map that is calibrated with the location of the implementing mobile communication device 103. The arrangement of the roads may include the width of the roads, the curvature of the roads, the number lanes in the road and the like. Additionally or alternatively, a potential collision course is calculated based on an analysis of the location of one or more other vehicles in proximity to the implementing mobile communication device 103. The presence of vehicles on the roads may be based on the analysis of all the received positioning data. For example, FIG. 3 depicts an exemplary road with three vehicles. If the alert managing module 104 detects that the user drives at vehicle marked with the numeral 1 and that another user that holds another mobile communication device 103 drives the vehicle that is marked with the numeral 3, a potential collision course may be the one marked with X. Such a potential collision course may be performed when vehicle 1 tries to bypass vehicle 2. In such an embodiment, the potential collision course may trigger the presentation of an alert or instructions to avoid the potential collision course, for example as described below.

Another example for a hazardous situation which may be detected by of the location of one or more other vehicles in proximity to the implementing mobile communication device 103 is a bypass performed when another vehicle is on a counter lane.

Other general examples for hazardous situations which may be detected by one of the aforementioned analyses are potential collision courses between a vehicle and a train, a vehicle and a pedestrian.

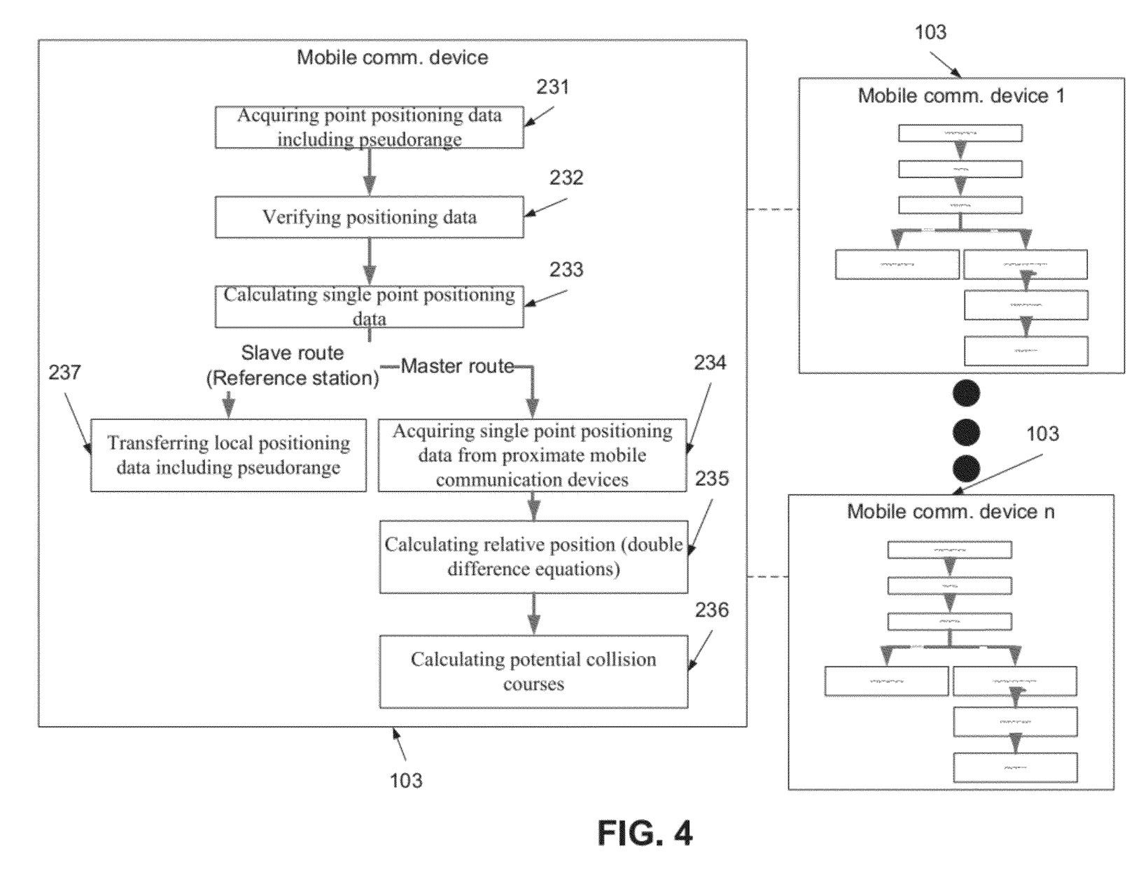

According to some embodiments of the present invention, the implementing mobile communication device 103 calculates the collision courses based on differential GPS (DGPS) calculations, referring to each one of the one more of the mobile communication device 103 as mobile reference stations. In such an embodiment, the positioning data that is acquired from each proximate mobile communication device 103 includes pseudorange, namely one or more approximations each of the distance between a certain GPS satellite and the respective mobile communication device 103, and navigation message which is indicative of the location of one or more satellites. This pseudorange allows the implementing mobile communication device 103 to reduce the error in the calculation of each one of the collision courses. It should be noted that the implementing mobile communication device 103 also provides pseudorange to the proximate mobile communication devices 103, allowing them to reduce the GPS error, for example for less than a meter, when implementing the process depicted in FIG. 2. For example reference is now also made to FIG. 4, which is a flowchart of processes which occur at the implementing mobile communication device 103 during 203 and 204, according to some embodiments of the present invention.

First, as shown at 231, a positioning data pertaining to the hosting mobile communication device 103 is acquired, for example using the positioning service module 105. This positioning data includes the respective coordinates and pseudorange. As shown at 232, this data is optionally verified by communicating with one or more of the proximate mobile communication devices 103. During the verification the differential corrections for location and optionally time are calculated for example according to the differential corrections which are performed by a reference station in a DGPS methodology, Now, a single point positioning is calculated, as shown at 233.

As shown at 234, single point positioning data from one or more of the proximate mobile communication devices 103 (1 . . . n) in the list is acquired, for example using P2P connections, as described above in relation to blocks 203, 204. Optionally, each proximate mobile communication devices 103 (1 . . . n) calculates its single point positioning data as described in 231-233. This single point positioning data optionally includes pseudorange and optionally coordinates which have been locally corrected, for example as described in 232, and optionally navigation message data which is indicative of the location of one or more satellites. Now, as shown at 235, relative position between the implementing and proximate mobile communication devices 103 is calculated.

Optionally, the relative position is calculated using pseudorange equations, such as double difference pseudorange measurements, see for example, Peter J. G. Teunissen, N. F. Jonkman and C. C. J. M. Tiberius, Weighting GPS Dual Frequency Observations: Bearing the Cross of Cross-Correlation, Volume 2, Number 2, 28-37, DOI: 10.1007/PL00000033, which is incorporated herein by reference.
This, as shown at 236, allows calculating the potential collision courses. Optionally, simultaneously, in order to function as a reference station for calculations of other mobile communication devices 103, the single point positioning data which includes the respective coordinates, pseudorange, and optionally navigation message data is transferred, for example via the P2P connections to the proximate mobile communication devices 103. As depicted in FIG. 4, these calculations may be performed optionally simultaneously, at each one of the mobile communication devices 103, over the P2P connections, for example reputably, for instance every about 1 second.

As shown at 205, a risk level is calculated per potential collision course. The risk level is optionally a value indicative of the level of the risk to the user of the implementing mobile communication device 103 from proximate drivers or pedestrians having the proximate mobile communication devices 103 and/or to the proximate drivers or pedestrians having the proximate mobile communication devices 103 from the user of the implementing mobile communication device 103. As used herein, a user also means a user and/or the vehicle which transports her. The risk level may be calculated according to the immediateness of the risk arising from the potential collision course, for example, what is the estimated time to collision and/or the last recorded distance, and/or the distance at the last communication event. Optionally, the risk level is calculated by one or more of the proximate mobile communication devices 103, for example based on positioning data which is received from the implementing mobile communication device 103, for instance with the request for positioning data. In such an embodiment, the risk level is sent via the network 110. Optionally, the calculated potential collision courses are prioritized according to these risk levels.

According to some embodiments of the present invention, the risk level may be estimated according to the driving profile of the users which are associated with the proximate mobile communication devices. The driving profile optionally includes a risk value indicative of the risk arising from the user when driving. This risk level is optionally calculated according to one or more location based events which are documented in the driving profile and the time of occurrence thereof. The location based events of each user are optionally detected by the alert managing module 104 of the respective mobile communication device 103, for example according to the positioning data acquired using the positioning service module 105. Optionally, a location based event is the detection of the presence of the mobile communication device 103 at locations which statistically have a relation to vehicle accidents, for example bars, clubs, and the like. Such a location based event may be detected by matching the positioning data with a map of such locations. Optionally, a location based event is a detection of a movement of a mobile communication device 103 at a driving velocity more than a certain period, for example more than two hours. Such a location based event may be detected by continually or intermittently sampling the positioning data of the mobile communication device 103.

Optionally, the risk level is calculated according to a combination of the level of proximity and technical data pertaining to the technical status of the user of the mobile communication device 103. For example the technical data may be extracted by the mobile communication device 103 from On-Board Diagnostics (OBDII) unit of the vehicle, for example using Bluetooth OBDII Connector. In such a manner, if the vehicle has a malfunction and/or did not perform a maintenance treatment for a long period or after a certain mileage, the risk level increases.

Optionally, the risk level is calculated according to a combination of the level of proximity and the velocity of the user of the mobile communication device 103.

Optionally, the risk level is calculated according to an analysis of the driving history that is documented in the driving profile. For example, the positioning data of the mobile communication device 103 is continually or intermittently sampled, stored at the driving profile, and analyzed to detect unsafe driving habits such as irregular velocity, frequent velocity changes, driving paths stability, sudden stops, sudden accelerations, sudden turns and the like. The reputation of such unsafe driving habits may change the risk level.

Optionally, the risk level is calculated according to a dynamic user profile of the user which may be based on data gathered from social network databases and/or websites. The dynamic user profile of the user may include data extracted from one or more social network web page(s) and/or feed(s) of the user, for example a Facebook™ and a Twitter™ feed. In such an embodiment, the detection of a recent status line, a recent location indication, and/or a recent post and/or upload may change the risk level. For example, if any of the words “alcohol”, “drinking”, “not sleeping”, “tired”, and/or “depressed” appear at the recent posts of the user, the risk level increases.

Optionally, the risk level is calculated according to a static user profile of the user. The static user profile of the user may include demographic data about the user, for example age, occupation, gender, and the like. In such an embodiment, the risk level may be adjusted according to statistical information about the demographic relation of the user.

Optionally, the risk level is calculated according to a usage in the mobile communication device 103 for human communication. In such an embodiment, the risk level may be increased when the user of the respective mobile communication device 103 use it for sending an SMS, sending an email, watching multimedia content, participating in an IM session, establishing a phone call and/or participating in a phone call, optionally without headset.

Optionally, as shown at 206, the potential collision courses are prioritized according to recent history and social elements. The prioritization may be performed according to the collusion risk levels.

Now, as shown at 207, an alert indicative of one or more risks, optionally prioritized are presented to the user of the implementing mobile communication device according to the calculated potential collision courses. The presentation is optionally performed by an integrated presentation unit 108 of the implementing mobile communication device, for example a speaker, a tactile unit, and/or the display. For example, the alert may be vocal, for example playing an alert stating the risk, for instance “Notice a driver from your right” or “Notice a pedestrian from your left”. Optionally, the presentation is visual, for example a map or a sign which is indicative of the location and/or direction of an estimated threat. Optionally, driving instructions, optionally prioritized, are presented to the user of the implementing mobile communication device according to the calculated potential collision courses. The presentation may be vocal, for example playing instructions, for instance “turn left”, “reduce velocity”, “do not bypass”, “keep away from the car ahead of you”, “do not change lane”, “danger ahead”, “increase velocity” and/or the like. It should be noted that providing instruction or an alert a second or few seconds before a possible collision, increases the reaction period of the user while driving and/or walking and therefore increase the chances of the user to avoid a vehicle accident. Additionally or alternatively, alert indicative of one or more risks are sent to the alert managing modules 104 of the proximate mobile communication devices 103 via the respective P2P connections. For example, if a potential collision course is detected with a vehicle driven by a user that is associated with a certain proximate mobile communication device, an alert message is sent thereto via a suitable P2P connection.

Optionally, as shown at 208, blocks 203-206 may be repeated continually or intermittently to allow calculating potential collision courses and optionally the prioritization thereof based on up-to-date positioning data. It should be noted that the traffic areas may be set so that the number of members in a group of a certain traffic area allows updating the potential collision courses in a relatively high rate, for example 10 times a minute per P2P connection. Optionally, the blocks 203-205 may be repeated continually or intermittently in an order set according to the prioritization. In such a manner, potential collision courses with users of proximate mobile communication devices 103 having a higher risk level are calculated before potential collision courses with users of proximate mobile communication devices 103 having a lower risk level.

Optionally, as shown at 209, an accident may be detected according to the analysis of the potential collusion courses. In such an embodiment the alert managing modules 104 may report a third party, such as an emergency service pertaining to the accident, for example by sending an automatic message and/or a voice message and/or by establishing a call with the third party using the services of the implementing mobile communication device 103. The sent message optionally indicates the location of the accident. Optionally, the potential collision courses are stored for future analysis. In such a manner, in a case of an accident, the potential collision courses may be provided as evidences. Alternatively, the data stored and tracked regarding the user remains anonymous. Optionally, the alert managing modules 104 communicates with cameras which are installed in the vehicle to instruct the operation thereof when potential collusion courses are detected. Optionally, the alert managing modules 104 record data from these cameras when potential collusion courses are detected.

According to some embodiments of the present invention, as shown at 210, the risk level may be calculated according to user history, a dynamic user profile, a static user profile, a usage in the mobile communication device 103, and/or a driving history of said mobile communication device 103 without taking into account the potential collision courses. In such embodiments, the alert (207) is indicative of a presence of a dangerous user in proximity to the user of the implementing mobile communication device 103 and not on a potential collision course.

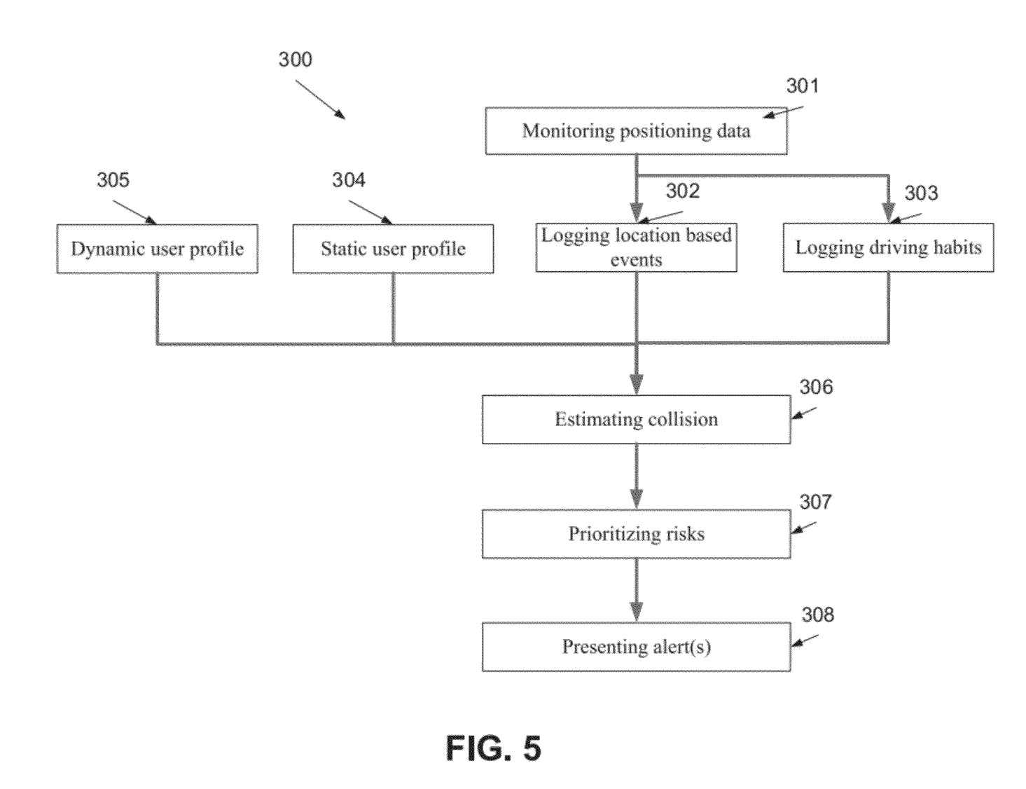

Reference is now also made to FIG. 5, which is a flowchart of a method of alerting driver(s) and/or pedestrian(s) about risks according to positioning data and additional user related data, according to some embodiments of the present invention. The method 300 is optionally implemented using the alert system 100 depicted in FIG. 1.

First, as shown at 301, the positioning data of a plurality of drivers and/or pedestrians carrying mobile communication devices, such as 103, is monitored in real time, for example using the aforementioned alert managing modules 104.

Then, as shown at 302, one or more location based events for each the mobile communication device 103 is logged, optionally according to the monitoring, for example as described above. Additionally or alternatively, as shown at 303, driving habits of each the mobile communication devices 103 is logged, optionally according to the monitoring, for example as described above. Additionally or alternatively, as shown at 304, the dynamic user profile of each the mobile communication device 103 is logged, for example as described above. Additionally or alternatively, as shown at 305, the static user profile of each the mobile communication device 103 is acquired or provided, for example as described above.

As shown at 306, proximity or potential proximity between some of the plurality of mobile communication devices 103 is detected according to monitored positioning data in real time, for example according to respective motion vectors and locations. Optionally, each of the plurality of mobile communication detects proximity to other of the plurality of mobile communication devices using P2P connections, for example as described above. Optionally, an estimated collision between some of said plurality of mobile communication devices is calculated, for example as described above.

This allows evaluating a risk level for a first user of mobile communication device from a second user of a second mobile communication device as a function of respective positioning data and respective location based events, static user profile, dynamic user profile, driving habits, and/or any combination thereof. Optionally, as shown at 307, risks per mobile communication device from other mobile communication devices are prioritized. In such a manner, immediate and/or clear risks can be handled before lee immediate and/or speculative risks.

Based on the evaluated risk, an alert indicative of the risk is presented to the user of the first mobile communication device in real time, as shown at 308.

It is expected that during the life of a patent maturing from this application many relevant systems and methods will be developed and the scope of the term a repository, a network, a central unit, a P2P connection and a mobile communication device is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of alerting a user of a mobile communication device having a processor about a risk arising from proximate drivers or pedestrians, comprising:
receiving a list of a plurality of proximate mobile communication devices from a central unit via a network;
establishing a peer to peer (P2P) connection with each said proximate mobile communication device;
acquiring positioning data from each said proximate mobile communication device via a respective said P2P connection;
calculating, using the processor, at least one potential collision course with at least one of said plurality of proximate mobile communication devices according to said positioning data; and
locally presenting an alert to the user according to said calculation.

2. The method of claim 1, wherein said positioning data comprises at least one of pseudorange and navigation message indicative of a location of at least one satellite.

3. The method of claim 1, wherein said positioning data comprises positioning coordinates corrected according to at least one of pseudorange and navigation message indicative of a location of at least one satellite.

4. The method of claim 1, wherein said calculating comprises calculating double difference pseudorange measurements according to said positioning data and using said double difference pseudorange measurements for determining said at least one potential collision course.

5. The method of claim 1, wherein said calculating comprises:
calculating a plurality of risk levels each according to another said potential collision course,
prioritizing said plurality of risk levels, and
generating said alert according to said prioritization.

6. The method of claim 5, further comprising repeating said calculating to update said prioritization.

7. The method of claim 5, wherein said prioritizing is performed to a sub group of said plurality of proximate mobile communication devices, said sub group is selected according to an analysis of said at least one potential collision.

8. The method of claim 1, wherein said calculating further comprises calculating at least one risk level according to said at least one potential collision course and at least one location based event of a respective said proximate mobile communication device.

9. The method of claim 8, wherein said at least one location based event is selected from a group consisting of a presence in an alcohol serving location, a presence in an unfamiliar region, a presence in vehicle moving longer than a certain period.

10. The method of claim 1, wherein said calculating further comprises at least one of calculating at least one risk level according to said at least one potential collision course and an analysis of driving history of a proximate user of a respective said proximate mobile communication device, detecting at least one accident bias driving habit of said proximate user according to said driving history, and calculating at least one risk level according to said at least one potential collision course and personal information of a user of a respective said proximate mobile communication device.

11. (canceled)

12. (canceled)

13. The method of claim 10, wherein said personal information is extracted from at least one of a social network page, a social network feed, and a social network activity of said user.

14. The method of claim 10, wherein said personal information comprises demographic data.

15. The method of claim 1, wherein said calculating further comprises calculating at least one risk level according to at least one of said at least one potential collision course and technical data of a vehicle driven by a user of a respective said proximate mobile communication device and said at least one potential collision course and a detection of human communication established via a respective said proximate mobile communication device.

16. (canceled)

17. The method of claim 1, further comprising performing a check to determine if respective said proximate mobile communication device is used for human communication; wherein said calculating further comprises calculating at least one risk level according to said at least one potential collision course and said check.

18. The method of claim 1, further comprising detecting an accident according to an analysis of said at least one potential collision course and forwarding a notification indicative of said accident to a remote control unit.

19-20. (canceled)

21. The method of claim 1, wherein said acquiring comprises sending a request for said positioning data to each said proximate mobile communication device via a respective said P2P connection and intercepting a response to said request.

22. (canceled)

23. A system of alerting a plurality of users of a plurality of mobile communication devices about risks arising from proximate drivers or pedestrians, comprising:
a central unit which monitors the location of a plurality of mobile communication devices in a plurality of groups each indicative of another of a plurality of traffic areas in a region; and
a plurality of client modules configured for being installed in said plurality of mobile communication devices so as to establish a plurality of peer to peer (P2P) connections among members of each said group;
wherein each client module receives a list defining a respective said group according to its respective said traffic area from said central unit, acquires positioning data from each member of said respective group via said respective P2P connections, calculates at least one potential collision course according to said positioning data, and locally presents an alert indicative of at least one risk to the respective user according to said at least one potential collision course.

24. (canceled)

25. The system of claim 23, wherein positioning data comprises location coordinates, movement direction, and velocity.

26. The system of claim 23, wherein said central unit computes and updates said plurality of groups according to positioning data received from said plurality of mobile communication devices via a wireless communication network in real time.

27. The system of claim 23, wherein said central unit computes said plurality of groups according to a member of a group consisting of: a traffic load, an estimated velocity of a vehicle, an estimated range of velocities of vehicles, an average period which driver spend in a traffic area, a mean of periods which drivers spend in a traffic area, a risk having an accidence in a traffic area, and statistical analysis of traffic patterns in a traffic area.

28. (canceled)

29. A method of alerting at least one of drivers and pedestrians about risks, comprising:
monitoring positioning data of each of a plurality of mobile communication devices in real time, each said mobile communication device being associated with at least one of a driver and a pedestrian;
logging at least one of a location based event and a driving habit for each said mobile communication device according to said positioning data;
detecting an accident prone proximity between first and second of said plurality of mobile communication devices according to respective said positioning data, in real time;
evaluating a risk for a first user of said first mobile communication device from a second user of said second mobile communication device as a function of respective said accident prone proximity and respective said at least one of said location based event and said driving habit; and
outputting an alert indicative of said risk to said first mobile communication device in real time.

30-31. (canceled)
